(19) United States
(12) Patent Application Publication
(10) Pub. No.: US 2019/0129338 A1
(43) Pub. Date: May 2, 2019

(54) IMAGE FORMING APPARATUS AND IMAGE FORMING METHOD

(71) Applicant: Oki Data Corporation, Tokyo (JP)

(72) Inventors: Yoshiki MATSUZAKI, Tokyo (JP); Toshihiro SHIMANUKI, Tokyo (JP)

(73) Assignee: Oki Data Corporation, Tokyo (JP)

(21) Appl. No.: 16/165,286

(22) Filed: Oct. 19, 2018

(30) Foreign Application Priority Data
Oct. 31, 2017 (JP) 2017-210914

(51) Int. Cl. G03G 15/00

(52) U.S. Cl. CPC G03G 15/50; G03G 15/6523

(57) ABSTRACT

An image forming apparatus includes an image forming section, a print medium conveying section, and a controller. The print medium conveying section conveys a continuous print medium to the image forming section. The controller receives job data and causes the image forming section to perform, on the continuous print medium, an image forming operation based on the job data. The job data includes cuttable position data related to a cuttable position on the continuous print medium. When a pause signal is received, the controller causes, on a basis of the cuttable position data, the image forming operation to be continued up to an image forming end position on the continuous print medium, and thereafter pauses the image forming operation. The pause signal gives an instruction to pause the image forming operation. The image forming end position corresponds to the cuttable position.

### CROSS REFERENCE TO RELATED APPLICATIONS

The present application claims priority from Japanese Patent Application No. 2017-210914 filed on Oct. 31, 2017, the entire contents of which are hereby incorporated by reference.

### BACKGROUND

The technology relates to an image forming apparatus and an image forming method each of which forms an image on a print medium.

Some of existing image forming apparatuses perform printing on a continuous print medium such as a roll of paper. Printing on such a continuous print medium sometimes involves interruption in a printing operation or output of a blank page as a result of a delay in supply of image data to an image forming section. One example technique that has been proposed to address this adjusts printing start timing by decoding, in advance, all pieces of data to be subjected to printing and estimating time necessary for printing, for example, as disclosed in Japanese Unexamined Patent Application Publication No. 2011-207121.

### SUMMARY

It is desired not to continue useless execution of a printing operation by promptly performing a process such as a pausing process or a printing stop process even during execution of printing on a continuous print medium.

It is desirable to provide an image forming apparatus and an image forming method that allow for improved operability.

According to one embodiment of the technology, there is provided an image forming apparatus that includes an image forming section, a print medium conveying section, and a controller. The print medium conveying section conveys a continuous print medium to the image forming section. The controller receives job data and causes the image forming section to perform, on the continuous print medium, an image forming operation based on the job data. The job data includes cuttable position data related to a cuttable position on the continuous print medium. When a pause signal is received, the controller causing, on the basis of the cuttable position data, the image forming operation to be continued up to an image forming end position on the continuous print medium, and thereafter pauses the image forming operation. The pause signal gives an instruction to pause the image forming operation. The image forming end position corresponds to the cuttable position.

According to one embodiment of the technology, there is provided an image forming apparatus that includes an image forming section, a print medium conveying section, and a controller. The print medium conveying section conveys a continuous print medium to the image forming section. The controller receives job data and causes the image forming section to perform, on the continuous print medium, an image forming operation based on the job data. The job data includes cuttable position data related to a cuttable position on the continuous print medium. When a pause signal is received, the controller discards remaining part of the job data, generates blank data, causes, on the basis of the cuttable position data, the image forming operation based on the blank data to be continued up to an image forming end position on the continuous print medium, and thereafter pauses the image forming operation. The pause signal gives an instruction to pause the image forming operation. The image forming end position corresponds to the cuttable position.

According to one embodiment of the technology, there is provided an image forming method including: conveying a continuous print medium to an image forming section; receiving job data, the job data including cuttable position data related to a cuttable position on the continuous print medium; causing the image forming section to perform, on the continuous print medium, an image forming operation based on the received job data; causing the image forming operation to be continued up to an image forming end position on the continuous print medium on the basis of the cuttable position data, when a pause signal is received, the pause signal giving an instruction to pause the image forming operation, the image forming end position corresponding to the cuttable position; and pausing the image forming operation after the causing the image forming operation to be continued up to the image forming end position on the continuous print medium, on the basis of the cuttable position data, when the pause signal is received.

According to one embodiment of the technology, there is provided an image forming method including: conveying a continuous print medium to an image forming section; receiving job data, the job data including cuttable position data related to a cuttable position on the continuous print medium; causing the image forming section to perform, on the continuous print medium, an image forming operation based on the received job data; discarding remaining part of the job data; generating blank data; causing the image forming operation based on the blank data to be continued up to an image forming end position on the continuous print medium, on the basis of the cuttable position data, when a pause signal is received, the pause signal giving an instruction to pause the image forming operation, the image forming end position corresponding to the cuttable position; and pausing the image forming operation after the causing the image forming operation based on the blank data to be continued up to the image forming end position on the continuous print medium, on the basis of the cuttable position data, when a pause signal is received.

### BRIEF DESCRIPTION OF DRAWINGS

FIG. 1 is a configuration diagram illustrating an example of a configuration of an image forming apparatus according to an embodiment of the technology.

FIG. 2 is an explanatory diagram illustrating an example of a configuration of a continuous print medium illustrated in FIG. 1.

FIG. 3 is a block diagram illustrating an example of a configuration of an image forming system including an image forming apparatus illustrated in FIG. 1.

FIG. 4 is a conceptual diagram describing a cuttable position, on a continuous print medium illustrated in FIG. 2, designated by cuttable position data.

FIG. 5A is a schematic diagram illustrating an example of an operation screen of an operation section illustrated in FIG. 3.

FIG. 5B is a schematic diagram illustrating another example of the operation screen of the operation section illustrated in FIG. 3.

FIG. 6A is a flowchart illustrating an example of a process flow of a main controller illustrated in FIG. 3.

FIG. 6B is another flowchart illustrating the example of the process flow of the main controller illustrated in FIG. 3.

FIG. 7 is a flowchart illustrating an example of a process flow of a print processor illustrated in FIG. 1.

FIG. 8 is a conceptual diagram describing an example of a process flow of the image forming apparatus illustrated in FIG. 1.

FIG. 9 is a conceptual diagram describing a process flow of an image forming apparatus according to a comparative example.

FIG. 10 is a flowchart illustrating an example of a process flow of an image forming apparatus according to a modification example.

### DETAILED DESCRIPTION

Hereinafter, some example embodiments of the technology will be described in detail with reference to the drawings. The description will be given in the following order. Note that the following description is directed to illustrative examples of the technology and not to be construed as limiting to the technology. Factors including, without limitation, numerical values, shapes, materials, components, positions of the components, dimensions, dimension ratios, and how the components are coupled to each other are illustrative only and not to be construed as limiting to the technology. Further, elements in the following example embodiments which are not recited in a most-generic independent claim of the technology are optional and may be provided on an as-needed basis. The drawings are schematic and are not intended to be drawn to scale. Note that the like elements are denoted with the same reference numerals, and any redundant description thereof will not be described in detail.

1. Example Embodiment (An example of an image forming apparatus that causes a printing operation to be continued up to a position corresponding to a cuttable position, and thereafter pauses the printing operation)
2. Modification Example (An example of an image forming apparatus that replaces part of job data with blank data, causes the printing operation to be continued up to the position corresponding to the cuttable position, and thereafter pauses the printing operation)

### 3. Other Modification Examples

### 1. Example Embodiment

### Example of Configuration of Image Forming Apparatus 10

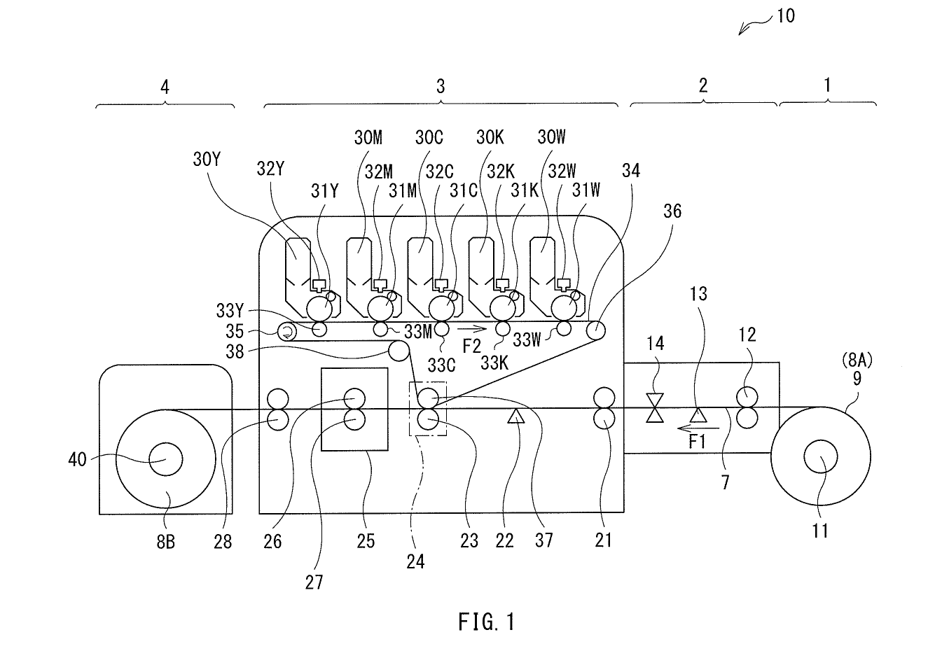

FIG. 1 illustrates an example of a configuration of an image forming apparatus (an image forming apparatus 10) according to an example embodiment of the technology. The image forming apparatus 10 may be a printer that forms an image on a continuous print medium 9 using an electrophotography method, for example. The continuous print medium 9 may be, for example but not limited to, a roll of paper. It is to be noted that an image forming method according to an example embodiment of the technology will be embodied by this example embodiment, and is therefore described together. The image forming apparatus 10 may include a print medium feeding section 1, a print medium conveying section 2, an image forming section 3, and a print medium take-up section 4.

The print medium feeding section 1 may feed the continuous print medium 9 to the print medium conveying section 2 and include a print medium holder 11. The print medium holder 11 may so hold a roll 8A that the roll 8A is rotatable. The roll 8A may be a roll of the continuous print medium 9. The print medium feeding section 1 may allow feeding of the continuous print medium 9 by causing the print medium holder 11 to rotate together with the roll 8A.

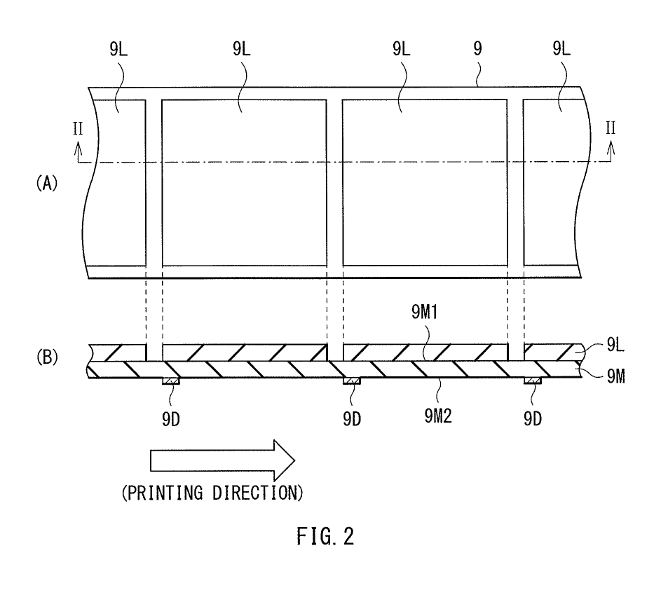

FIG. 2 illustrates an example of a configuration of the continuous print medium 9. Part (A) of FIG. 2 illustrates an example of a surface of the continuous print medium 9, i.e., a label surface. Part (B) of FIG. 2 illustrates an example a cross-section taken along a line II-II in Part (A) of FIG. 2. The continuous print medium 9 may include a plurality of labels 9L and a mount 9M. The labels 9L may be disposed side by side at predetermined intervals in a longitudinal direction of the continuous print medium 9 on a front surface 9M1 of the mount 9M. The labels 9L may be temporarily attached to the front surface 9M1 of the mount 9M. Further, a marker 9D may be printed on a rear surface 9M2 of the mount 9M. In the example illustrated in FIG. 2, the marker 9D may be provided at a front end of each of the labels 9L in a direction in which the labels 9L are disposed side by side, i.e., a printing direction along the longitudinal direction of the continuous print medium 9. It is to be noted that, however, the technology is not limited thereto. For example, the marker 9D may be provided at a position corresponding to a space between the labels 9L adjacent to each other in the direction in which the labels 9L are disposed side by side, i.e., the longitudinal direction of the continuous print medium 9.

The print medium conveying section 2 may convey the continuous print medium 9, fed from the print medium feeding section 1, toward the image forming section 3 in a conveyance direction F1. The print medium conveying section 2 may include a conveying roller 12, a label sensor 13, and a cutter 14 that are provided along a conveyance path 7 through which the continuous print medium 9 is to pass, as illustrated in FIG. 1.

The conveying roller 12 may include a pair of rollers that face each other with the conveyance path 7 in between. The conveying roller 12 may pull out the continuous print medium 9 from the roll 8A and convey the pulled-out continuous print medium 9 along the conveyance path 7.

The label sensor 13 may detect a position of the label 9L of the continuous print medium 9. In one example, the label sensor 13 may include a reflective sensor and detect the position of the label 9L by detecting the marker 9D on the basis of reflection of light applied to a rear surface of the continuous print medium 9. Further, the image forming apparatus 10 may determine, on the basis of a result of the detection performed by the label sensor 13, a position, on the continuous print medium 9, to be cut by the cutter 14.

The cutter 14 may cut the continuous print medium 9. The cutter 14 may refer to the result of the detection performed by the label sensor 13. The cutter 14 may cut the continuous print medium 9 on the basis of the referred result of the detection performed by the label sensor 13 and of print job data received from a higher-level device 110 which will be described later. The cutter 14 may thereby cut the continuous print medium 9, for example, on the basis of the predetermined number of labels 9L designated by a user.

The image forming section 3 may perform a printing operation, i.e., an image forming operation that forms an image on a label surface of the continuous print medium 9 fed from the print medium feeding section 1. The image forming section 3 may include five image forming units 30, five exposure units 32, five primary transfer rollers 33, a transfer belt 34, a drive roller 35, an idle roller 36, a secondary transfer backup roller 37, and an idle roller 38. The five image forming units 30 may include image forming units 30Y, 30M, 30C, 30K, and 30W. The five exposure units 32 may include exposure units 32Y, 32M, 32C, 32K, and 32W. The five primary transfer rollers 33 may include primary transfer rollers 33Y, 33M, 33C, 33K, and 33W.

The five image forming units 30 may each form a toner image. For example, the image forming unit 30Y may form a yellow toner image. The image forming unit 30M may form a magenta toner image. The image forming unit 30C may form a cyan toner image. The image forming unit 30K may form a black toner image. The image forming unit 30W may form a white toner image. The image forming units 30Y, 30M, 30C, 30K, and 30W may be disposed in this order in a conveyance direction F2 in which the transfer belt 34 is to be conveyed.

The five image forming units 30 may each include a photosensitive member 31. For example, the image forming unit 30Y may include a photosensitive member 31Y. The image forming unit 30M may include a photosensitive member 31M. The image forming unit 30C may include a photosensitive member 31C. The image forming unit 30K may include a photosensitive member 31K. The image forming unit 30W may include a photosensitive member 31W. A surface of each of the photosensitive members 31 may be submitted to exposure by the corresponding exposure unit 32, and be thereby provided with an electrostatic latent image thereon. Thereafter, the corresponding toner may be supplied and the toner image may be thereby formed or developed in accordance with the provided electrostatic latent image.

The five exposure units 32 may each apply light to the photosensitive member 31 of the corresponding one of the five image forming units 30. For example, the exposure unit 32Y may apply light to the photosensitive member 31Y. The exposure unit 32M may apply light to the photosensitive member 31M. The exposure unit 32C may apply light to the photosensitive member 31C. The exposure unit 32K may apply light to the photosensitive member 31K. The exposure unit 32W may apply light to the photosensitive member 31W.

The five primary transfer rollers 33 may each electrostatically transfer, onto a transfer surface of the transfer belt 34, the toner image formed by corresponding one of the five image forming units 30. The primary transfer roller 33Y may face the photosensitive member 31Y with the transfer belt 34 in between. The primary transfer roller 33M may face the photosensitive member 31M with the transfer belt 34 in between. The primary transfer roller 33C may face the photosensitive member 31C with the transfer belt 34 in between. The primary transfer roller 33K may face the photosensitive member 31K with the transfer belt 34 in between. The primary transfer roller 33W may face the photosensitive member 31W with the transfer belt 34 in between. The primary transfer rollers 33 may each receive a predetermined primary transfer voltage. Thus, the image forming apparatus 10 may cause the toner images formed by the respective image forming units 30 to be transferred onto the transfer surface of the transfer belt 34. In other words, the image forming apparatus 10 may thus cause primary transfer to be performed.

The transfer belt 34 may support the toner images on the transfer surface and convey the toner images to a secondary transfer section 24 which will be described later. The transfer belt 34 may be an endless elastic belt including an electrically-semiconductive plastic film having high resistance, for example. The transfer belt 34 may lie on the drive roller 35, the idle roller 36, the secondary transfer backup roller 37, and the idle roller 38 while being stretched. Further, the transfer belt 34 may rotate circularly in accordance with rotation of the drive roller 35.

The drive roller 35 may cause the transfer belt 34 to rotate circularly. In this example, the drive roller 35 may be disposed upstream of the five image forming units 30 in the conveyance direction F2 of the transfer belt 34. The drive roller 35 may rotate clockwise in this example by means of driving force transmitted from an unillustrated transfer belt motor. The drive roller 35 may thereby cause the transfer belt 34 to rotate circularly in the conveyance direction F2.

The idle roller 36 may be rotated clockwise in this example in accordance with the circular rotation of the transfer belt 34. The idle roller 36 may be disposed downstream of the five image forming units 30 in the conveyance direction F2 of the transfer belt 34 in this example.

The secondary transfer backup roller 37 may be rotated clockwise in this example in accordance with the circular rotation of the transfer belt 34. The secondary transfer backup roller 37 may face a later-described secondary transfer roller 23 with both the conveyance path 7 and the transfer belt 34 in between. The secondary transfer backup roller 37 may configure the secondary transfer section 24 together with the secondary transfer roller 23.

The idle roller 38 may be rotated counterclockwise in this example in accordance with the circular rotation of the transfer belt 34. The idle roller 38 may be disposed downstream of the secondary transfer section 24 in the conveyance direction F2 of the transfer belt 34.

The image forming section 3 may further include a conveying roller 21, a label sensor 22, the secondary transfer roller 23, a fixing section 25, and a conveying roller 28.

The conveying roller 21 may include a pair of rollers that are disposed with the conveyance path 7 in between. The conveying roller 21 may convey the continuous print medium 9, fed from the print medium conveying section 2, along the conveyance path 7 toward the secondary transfer section 24.

The label sensor 22 may detect the position of the label 9L of the continuous print medium 9. In one example, the label sensor 22 may include a reflective sensor and detect the position of the label 9L by detecting the marker 9D on the basis of reflection of light applied to the rear surface of the continuous print medium 9. Further, the image forming apparatus 10 may adjust, on the basis of a result of the detection performed by the label sensor 22, a position, on the continuous print medium 9, at which the toner images are to be transferred.

The secondary transfer roller 23 may transfer the toner image on the transfer surface of the transfer belt 34 onto the label 9L of the continuous print medium 9. The secondary transfer roller 23 may face the secondary transfer backup roller 37 with both the conveyance path 7 and the transfer belt 34 in between. The secondary transfer roller 23 may configure the secondary transfer section 24 together with the secondary transfer backup roller 37. The secondary transfer roller 23 may receive a predetermined secondary transfer voltage. Thus, the image forming apparatus 10 may cause the toner image on the transfer surface of the transfer belt 34 to be transferred onto the label 9L of the continuous print medium 9. In other words, the image forming apparatus 10 may thus cause secondary transfer to be performed.

The fixing section 25 may fix, to the continuous print medium 9, the toner image transferred onto the continuous print medium 9, by applying heat and pressure to the continuous print medium 9. The fixing section 25 may include a heat roller 26 and a pressure-applying roller 27. The heat roller 26 may include a heater such as a halogen lamp inside the heat roller 26, for example. The heat roller 26 may apply heat to the toner on the continuous print medium 9. The pressure-applying roller 27 may be so disposed that a pressure contact is formed between the pressure-applying roller 27 and the heat roller 26. The pressure-applying roller 27 may apply pressure to the toner on the continuous print medium 9. The fixing section 25 may thus cause the toner on the continuous print medium 9 to be heated, melted, and applied with pressure. As a result, the toner image may be fixed onto the continuous print medium 9.

The conveying roller 28 may include a pair of rollers that face each other with the conveyance path 7 in between. The conveying roller 28 may convey the continuous print medium 9 along the conveyance path 7 toward the print medium take-up section 4.

The print medium take-up section 4 may take up the continuous print medium 9 fed from the image forming section 3. The print medium take-up section 4 may include a print medium holder 40 that so holds a roll 8B that the roll 8B is rotatable. The roll 8B may be a roll of the continuous print medium 9 that has been taken up. The print medium take-up section 4 may cause the print medium holder 40 to rotate and thereby take up the continuous print medium 9, which is considered as the roll 8B.

### [Control Mechanism of Image Forming Apparatus 10]

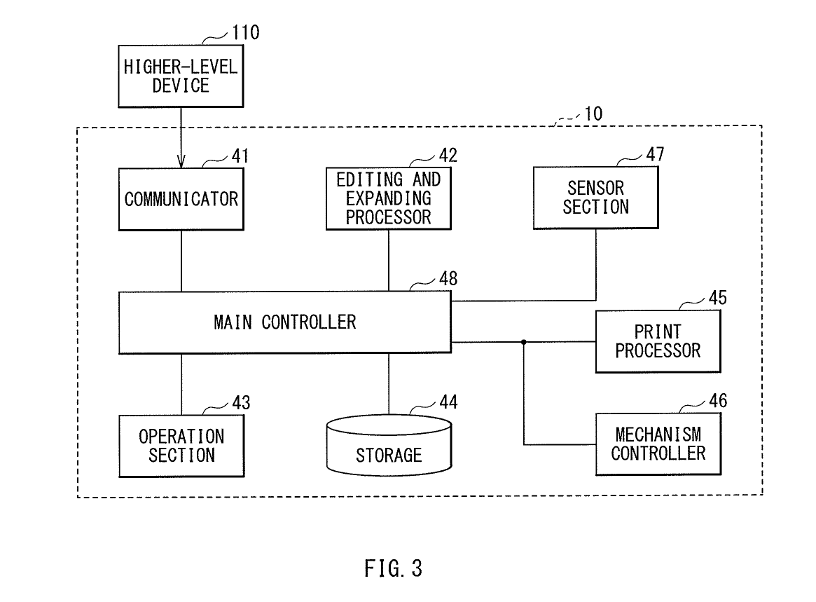

FIG. 3 is a block diagram illustrating an example of a control mechanism of the image forming apparatus 10. The image forming apparatus 10 may include, as its control mechanism, a communicator 41, an editing and expanding processor 42, an operation section 43, storage 44, a print processor 45, a mechanism controller 46, a sensor section 47, and a main controller 48.

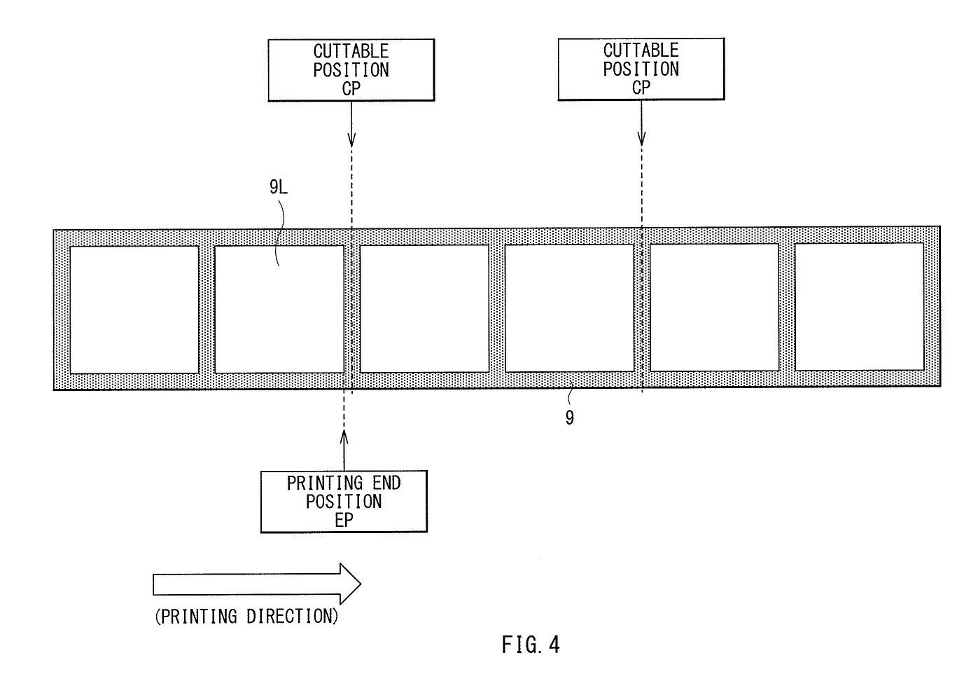

The communicator 41 may perform communication by means of a local area network (LAN), universal serial bus (USB), or a Centronics port, for example. The communicator 41 may receive the print job data supplied from the higher-level device 110 such as a host computer, for example. It is to be noted that the print job data may correspond to “job data” in one specific but non-limiting embodiment of the technology. The print job data includes cuttable position data. Referring to FIG. 4, the cuttable position data may include information related to a position at which the continuous print medium 9 is cuttable by the cutter 14. The position at which the continuous print medium 9 is cuttable by the cutter 14 will be hereinafter referred to as a cuttable position CP. FIG. 4 is a conceptual diagram describing the cuttable position CP on the continuous print medium 9 designated by the cuttable position data. A terminal end of the label 9L immediately before the cuttable position CP in the printing direction may be referred to as a printing end position EP, as illustrated in FIG. 4. The printing end position EP may correspond to an “image forming end position” in one specific but non-limiting embodiment of the technology. In FIG. 4, printing may be performed in order from the label 9L on the left side of the paper plane toward the label 9L on the right side of the paper plane.

The editing and expanding processor 42 may edit and expand the print job data received by the communicator 41 and thereby generate image data, e.g., bitmap data.

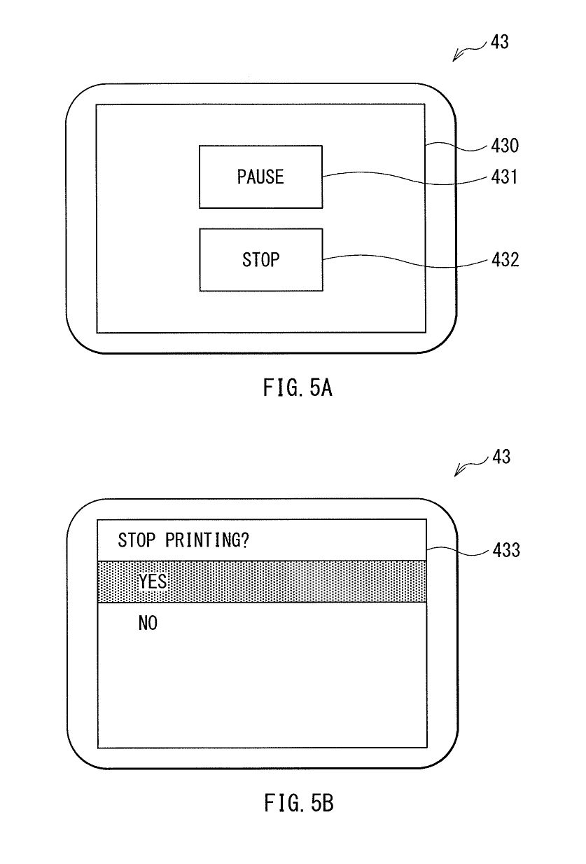

The operation section 43 may receive an operation performed by the user. The operation section 43 may include, for example, various hardware keys such as an operation button and a display section such as a liquid crystal display. The operation section 43 may supply to the main controller 48, for example: an execution signal giving an instruction to execute the printing operation of the image forming section 3; a pause signal giving an instruction to pause the printing operation; a cancel signal giving an instruction to cancel the pausing of the printing operation; and a stop signal giving an instruction to stop the printing operation. FIGS. 5A and 5B each schematically illustrate an example of an operation screen of the operation section 43. FIG. 5A illustrates an example of an operation screen 430 including a printing pause button 431 and a printing stop button 432. FIG. 5B illustrates an example of a stop confirmation waiting screen 433 that is to be displayed on the operation section 43 when the printing stop button 432 is operated.

The storage 44 may hold the image data generated by the editing and expanding processor 42.

The print processor 45 may form, on the photosensitive member 31, an image based on the image data generated by the editing and expanding processor 42, and control the printing operation of the image forming section 3. The print processor 45 may include two regional parts, i.e., controller firmware and engine firmware. The controller firmware may buffer the image data that has been subjected to the editing and expanding process by the editing and expanding processor 42, and put the image data into a print queue. The engine firmware may control, on the basis of the print queue, a voltage to be applied to the image forming section 3 when the image forming section 3 executes the printing operation. It is to be noted that the print queue may be a buffer having a first-in-first-out (FIFO) structure and may be used to supply the engine firmware with the image data to be printed.

The mechanism controller 46 may perform a drive control of a component such as the conveying roller 12 of the print medium conveying section 2, the cutter 14, various rollers of the image forming section 3, or the print medium holder 40 of the print medium take-up section 4.

The sensor section 47 may be a level sensor that detects a remaining amount of each of the toners in the five image forming units 30, for example. The sensor section 47 may detect the remaining amount of each of the toners in the five image forming units 30, and supply a remaining amount alarming signal to the main controller 48 when the remaining amount is lower than a lower limit value. It is to be noted that the sensor section 47 may correspond to a “sensor” in one specific but non-limiting embodiment of the technology. The remaining amount alarming signal may correspond to an “error signal” in one specific but non-limiting embodiment of the technology.

The main controller 48 may control a general operation of the image forming apparatus 10 by controlling operations of respective units in the image forming apparatus 10. The main controller 48 may correspond to a “controller” in one specific but non-limiting embodiment of the technology. It is to be noted that a function of the main controller 48 may be achieved, for example, by means of hardware or software.

### Example Operations and Example Workings of Image Forming Apparatus 10

Next, a description will be given below of example operations and example workings of the image forming apparatus 10 according to an example embodiment of the technology.

[Outline of General Operation] A description will be given first of an outline of a general operation of the image forming apparatus 10 referring to FIGS. 1 and 3. When the communicator 41 receives the print job data from the higher-level device 110, the main controller 48 may so control respective blocks of the image forming apparatus 10 as to cause the image forming apparatus 10 to perform the printing operation. The editing and expanding processor 42 may generate the image data on the basis of the print job data. On the basis of the image data generated by the editing and expanding processor 42, the print processor 45 may control the operations of the respective five exposure units 32 and generate various voltages directed to the printing operation. Non-limiting examples of the various voltages directed to the printing operation may include a charging voltage, a developing voltage, a feeding voltage, a primary transfer voltage, or a secondary transfer voltage. The mechanism controller 46 may control operations of various motors in the image forming apparatus 10 such as a photosensitive member motor or a transfer belt motor.

In each of the five image forming units 30, an electrostatic latent image may be formed on a surface of the corresponding photosensitive member 31, and a toner image may be formed or developed in accordance with the formed electrostatic latent image. Each of the five primary transfer rollers 33 may transfer, onto the transfer surface of the transfer belt 34, the toner image formed on the photosensitive member 31 of the corresponding image forming unit 30. In other words, each of the five primary transfer rollers 33 may perform primary transfer. The toner image on the transfer belt 34 may be conveyed to the secondary transfer section 24 as a result of the circular rotation of the transfer belt 34.

The conveying roller 12 may pull the continuous print medium 9 out from the roll 8A in the print medium feeding section 1 and convey the pulled-out continuous print medium 9 along the conveyance path 7. The label sensor 13 may detect the position of the label 9L of the continuous print medium 9. The cutter 14 may cut the continuous print medium 9 on the basis of the result of the detection performed by the label sensor 13 and of the print job data received from the higher-level device 110. The cutter 14 may thereby cut the continuous print medium 9, for example, on the basis of the predetermined number of labels 9L designated by the user. The conveying roller 21 may convey the continuous print medium 9 toward the downstream along the conveyance path 7. The label sensor 22 may detect the position of the label 9L of the continuous print medium 9.

The secondary transfer section 24 may transfer, onto the label surface of the continuous print medium 9, the toner image on the transfer surface of the transfer belt 34. The label surface of the continuous print medium 9 may be a transfer surface of the continuous print medium 9. In other words, the secondary transfer section 24 may perform secondary transfer. The fixing section 25 may fix the toner image to the continuous print medium 9. The conveying roller 28 may discharge, from the image forming section 3, the continuous print medium 9 to which the toner image is fixed by the fixing section 25.

The print medium take-up section 4 may cause the print medium holder 40 to rotate on the basis of the control performed by the mechanism controller 46, and thereby take up, as the roll 8B, the continuous print medium 9 discharged from the image forming section 3.

### [Regarding Process Flow of Main Controller 48]

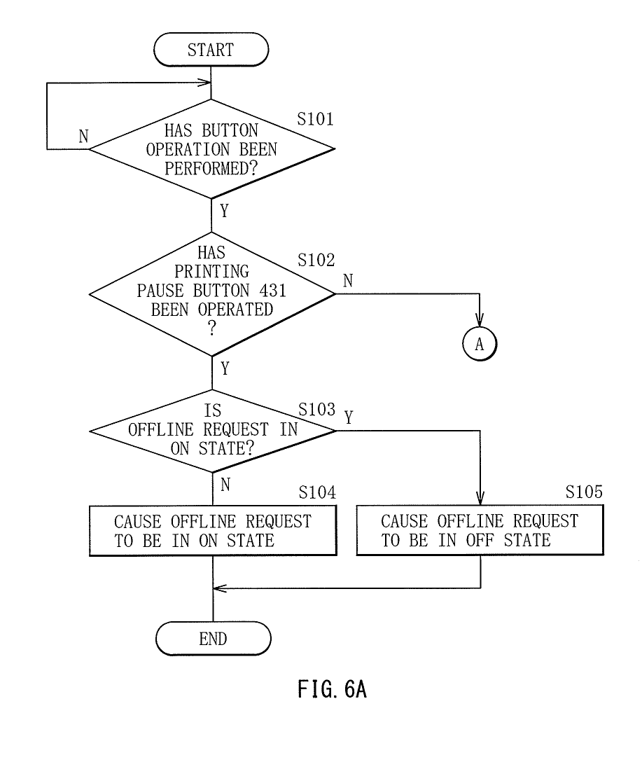

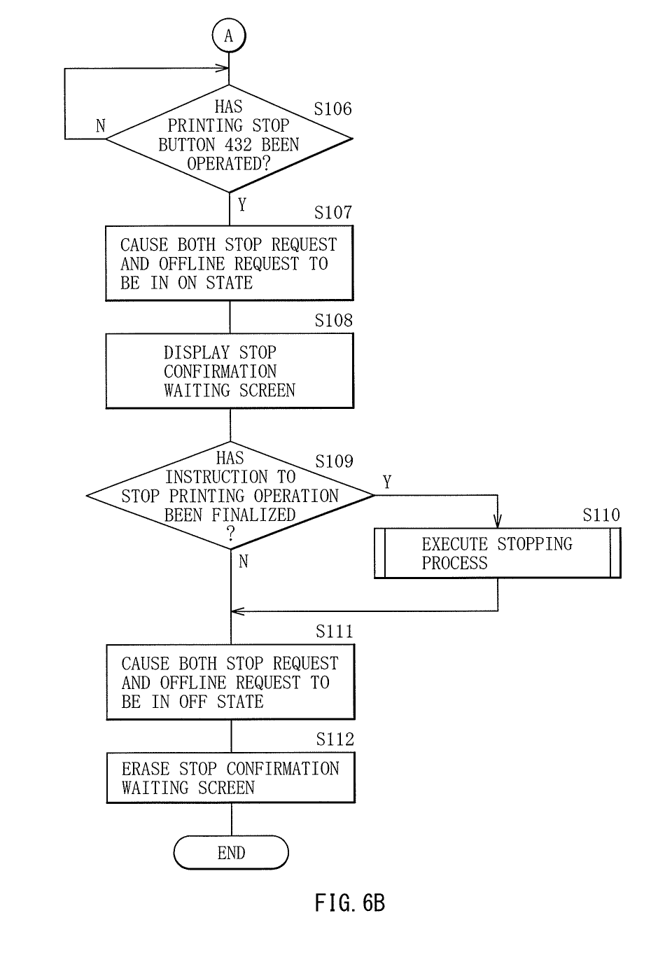

A description will be given next regarding a process flow of the main controller 48 with reference to FIGS. 6A and 6B. FIGS. 6A and 6B are each a flowchart illustrating an example of a process flow of the main controller 48.

Referring to FIG. 6A, the main controller 48 may first confirm whether a button operation has been performed on the operation section 43 (step S101). The main controller 48 may repeat the process in step S101 until the main controller 48 confirms that the button operation has been performed on the operation section 43 (N in S101).

When the main controller 48 confirms in step S101 that the button operation has been performed on the operation section 43 (Y in step S101), the main controller 48 may confirm whether the printing pause button 431 has been operated (step S102). When the printing pause button 431 is operated, the pause signal may be supplied from the operation section 43 to the main controller 48, allowing the main controller 48 to recognize that the printing pause button 431 has been operated. When the main controller 48 confirms that the printing pause button 431 has been operated (Y in step S102), the main controller 48 may confirm whether an offline request is in an ON state (step S103). When the main controller 48 determines that the offline request is not in the ON state in step S103 (N in step S103), the main controller 48 may cause an offline request to be in the ON state (step S104), and thereafter bring the flow to the end. In contrast, when the main controller 48 determines in step S103 that an offline request is in the ON state (Y in step S103), the main controller 48 may cause the offline request to be in an OFF state (step S105), and thereafter bring the flow to the end. It is to be noted that the user may be able to cause the offline request to be in the OFF state by operating the printing pause button 431 again on the operation screen 430 of the operation section 43.

When the main controller 48 cannot confirm in step S102 illustrated in FIG. 6A that the printing pause button 431 has been operated (N in step S102), the main controller 48 may confirm whether the printing stop button 432 has been operated, as illustrated in FIG. 6B (step S106). When the printing stop button 432 is operated, the stop signal may be supplied from the operation section 43 to the main controller 48, allowing the main controller 48 to recognize that the printing stop button 432 has been operated. When the main controller 48 confirms that the printing stop button 432 has been operated (Y in step S106), the main controller 48 may cause both a stop request and an offline request to be in the ON state (step S107), and further, cause the operation section 43 to display the stop confirmation waiting screen 433 illustrated in FIG. 5B on the operation screen of the operation section 43 (step S108). Thereafter, the main controller 48 may confirm whether the user has selected “Yes” on the stop confirmation waiting screen 433 illustrated in FIG. 5B and an instruction to stop the printing operation has been finalized (step S109). When the main controller 48 confirms that the instruction to stop the printing operation has been finalized (Y in step S109), the main controller 48 may so control the operations of the respective units in the image forming apparatus 10 as to execute the process of stopping the printing operation (step S110). After the process of stopping the printing operation is executed, the main controller 48 may cause both of the stop request and the offline request to be in the OFF state (step S111), and further, cause the operation section 43 to erase the stop confirmation waiting screen 433 displayed on the operation screen of the operation section 43 (step S112). It is to be noted that, when the main controller 48 cannot confirm that the instruction to stop the printing operation has been finalized (N in step S109N), the main controller 48 may sequentially perform the respective processes in step S111 and step S112 without bringing the process of stopping the printing operation into execution. Thereafter, the main controller 48 may bring the process flow of the operation section 43 to the end.

### [Regarding Process Flow of Print Processor 45]

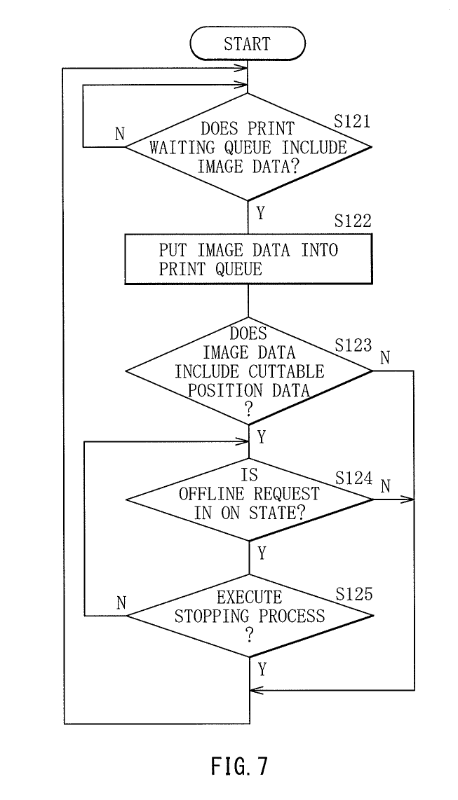

A description will be given next of a process flow of the print processor 45 with reference to FIG. 7. FIG. 7 is a flowchart illustrating an example of a process flow of the print processor 45.

Referring to FIG. 7, the print processor 45 may first confirm whether the print waiting queue includes the image data that has been subjected to the editing and expanding process by the editing and expanding processor 42 (step S121). The print waiting queue referred to above may be a buffer that has the FIFO structure and is to hold the image data subjected to the editing and expanding process by the editing and expanding processor 42. The print processor 45 may repeat the process in step S121 until the print processor 45 confirms that the print waiting queue includes the image data that has been subjected to the editing and expanding process by the editing and expanding processor 42 (N in step S121).

When the print processor 45 confirms in step S121 that the print waiting queue includes the image data (Y in step S121), the print processor 45 may take the image data out of the print waiting queue and put the taken-out image data into the print queue (step S122).

Thereafter, the print processor 45 may confirm whether the image data put into the print queue in step S122 includes the cuttable position data related to the continuous print medium 9 (step S123). The cuttable position data related to the continuous print medium 9 may indicate the cuttable position on the continuous print medium 9 at which the continuous print medium 9 is to be cut by the cutter 14. When the print processor 45 determines in step S123 that the image data put into the print queue does not include the cuttable position data related to the continuous print medium 9 (N in step S123), the print processor 45 may return to the process in step S121.

When the print processor 45 determines in step S123 that the image data put into the print queue includes the cuttable position data related to the continuous print medium 9 (Y in step S123), the print processor 45 may confirm whether an offline request is in the ON state or the OFF state (step S124). When the print processor 45 confirms in step S124 that the offline request is in the OFF state (N in step S124), the print processor 45 may return to the process in step S121.

When the print processor 45 confirms in step S124 that the offline request is in the ON state (Y in step S124), the print processor 45 may confirm whether the main controller 48 has so controlled the operations of the respective units in the image forming apparatus 10 as to execute the process of stopping the printing operation (step S125). When the print processor 45 cannot confirm that the main controller 48 has so controlled the operations of the respective units in the image forming apparatus 10 as to execute the process of stopping the printing operation (N in step S125), the print processor 45 may return to the process in step S124. In contrast, when the print processor 45 confirms that the main controller 48 has so controlled the operations of the respective units in the image forming apparatus 10 as to execute the process of stopping the printing operation (Y in step S125), the print processor 45 may return to the process in step S121.

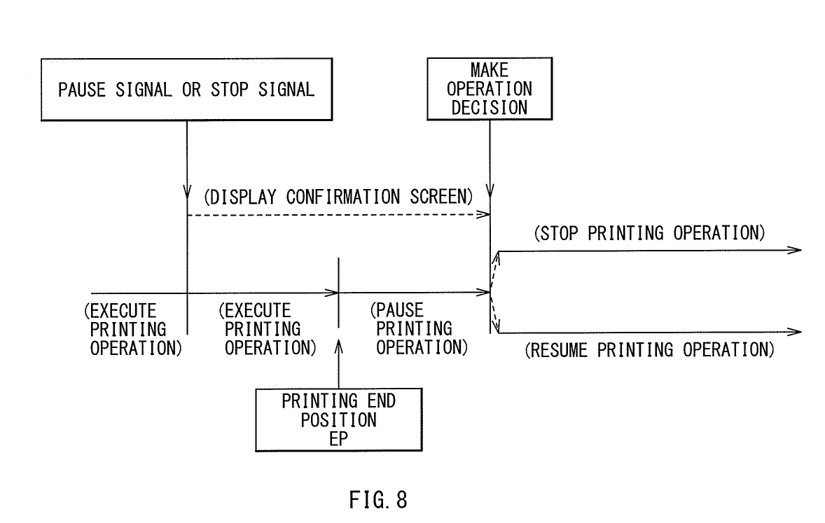

As described above, in the image forming apparatus 10 according to an example embodiment of the technology, the printing operation of the image forming section 3 may be executed on the basis of a command given by the main controller 48, when the print processor 45 determines that the image data put into the print queue includes the cuttable position data related to the continuous print medium 9. In the example described above, the main controller 48 may receive the pause signal supplied from the operation section 43, when the printing pause button 431 is operated by the user. Upon receiving the pause signal, the main controller 48 may cause the printing operation of the image forming section 3 to be continued up to the printing end position EP and thereafter pause the printing operation, on the basis of the cuttable position data, as illustrated in FIG. 8. The printing end position EP may correspond to the cuttable position CP on the continuous print medium 9.

Further, the main controller 48 may receive the stop signal supplied from the operation section 43, when the printing stop button 432 is operated by the user. Upon receiving the stop signal, the main controller 48 may cause the printing operation of the image forming section 3 to be continued up to the printing end position EP and thereafter pause the printing operation, on the basis of the cuttable position data, as illustrated in FIG. 8. The printing end position EP may correspond to the cuttable position CP on the continuous print medium 9. Further, the main controller 48 may cause the stop request and the offline request to be in the ON state (step S107 in FIG. 6B). Further, the main controller 48 may make an operation decision that decides to stop the printing operation or to resume the printing operation, as illustrated in FIG. 8. In other words, when the main controller 48 confirms that the instruction to stop the printing operation has been finalized (Y in step S109 of FIG. 6B), the main controller 48 may cause the process of stopping the printing operation to be executed (step S110 in FIG. 6B). It is to be noted that, after receiving the stop signal, the main controller 48 may discard the print job data and stop the printing operation when the instruction to stop the printing operation has been finalized. In contrast, the main controller 48 may resume the printing operation when the main controller 48 cannot confirm that the instruction to stop the printing operation has been finalized (N in step S109 of FIG. 6B).

Accordingly, referring to FIG. 8, it is possible for the image forming apparatus 10 according to an example embodiment of the technology to pause the printing operation during part of a period from the time when the main controller 48 receives one of the pause signal and the stop signal to the time when the operation decision is made by the user. For example, it is possible for the main controller 48 to cause the printing operation of the image forming section 3 to be continued up to the printing end position EP, and thereafter pause the printing operation.

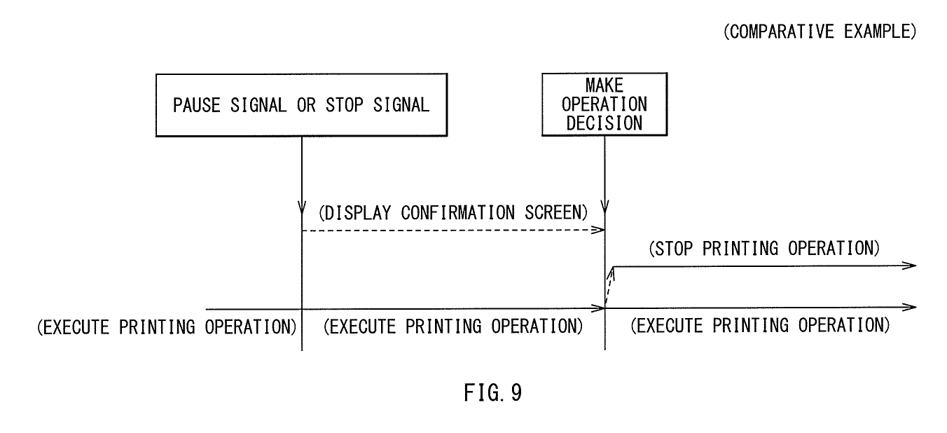

In contrast, referring to FIG. 9, a typical image forming apparatus continues the printing operation until stopping of the printing operation is finalized after a button such as the printing pause button or the printing stop button is operated.

Moreover, in the image forming apparatus 10 according to an example embodiment of the technology, the remaining amounts of the respective toners in the five image forming units 30 may be detected by the sensor section 47, causing the remaining amount alarming signal to be supplied to the main controller 48 when any of the remaining amounts of the respective toners is smaller than the lower limit value of the corresponding toner. This may allow the main controller 48 receiving the remaining amount alarming signal, for example, to automatically cause an offline request to be in the ON state and thereby pause the printing operation of the image forming section 3. In one example of this case, the main controller 48 may cause the printing operation to be continued up to the printing end position EP, and thereafter pause the printing operation, on the basis of the cuttable position data.

### Example Effects of Image Forming Apparatus 10

As described above, it is possible for the image forming apparatus 10 according to an example embodiment of the technology to pause the printing operation during part of the period from the time when the main controller 48 receives one of the pause signal and the stop signal to the time when the operation decision is made by the user. This reduces useless execution of the printing operation when the stopping of the printing operation is finalized. Accordingly, for example, the use of the toner, electric power consumption, or operating time is reduced. Therefore, according to an example embodiment of the technology, the printing operation is allowed to be promptly paused, which avoids useless continuation of the printing operation. Hence, it is possible to achieve improved operability.

Moreover, it is possible for the image forming apparatus 10 according to an example embodiment of the technology to detect the remaining amount of each toner in the image forming section 3 by the sensor section 47 and automatically pause the printing operation of the image forming section 3 when the remaining amount of toner is insufficient. This makes it possible to exchange the toner also before completion of the printing, on the continuous print medium 9, corresponding to all of the print job data. It is to be noted that, although the example embodiment has been described above referring to the detection of the remaining amount of the toner and the exchange of the toner as examples, the technology is not limited thereto. For example, an exchange due to a factor such as the end of the life or failure of the photosensitive member 31, the exposure unit 32, etc. may be also achievable in a similar manner.

### 2. Modification Example

In the example embodiment described above, the usual printing operation may be continued up to the printing end position EP corresponding to the cuttable position CP and the printing operation may be paused thereafter. In contrast, according to a modification example, part of the print job data may be replaced with blank data, the printing operation may be thus continued up to the printing end position EP, and thereafter, the printing operation may be paused.

### [Regarding Process Flow of Printing Processor 45]

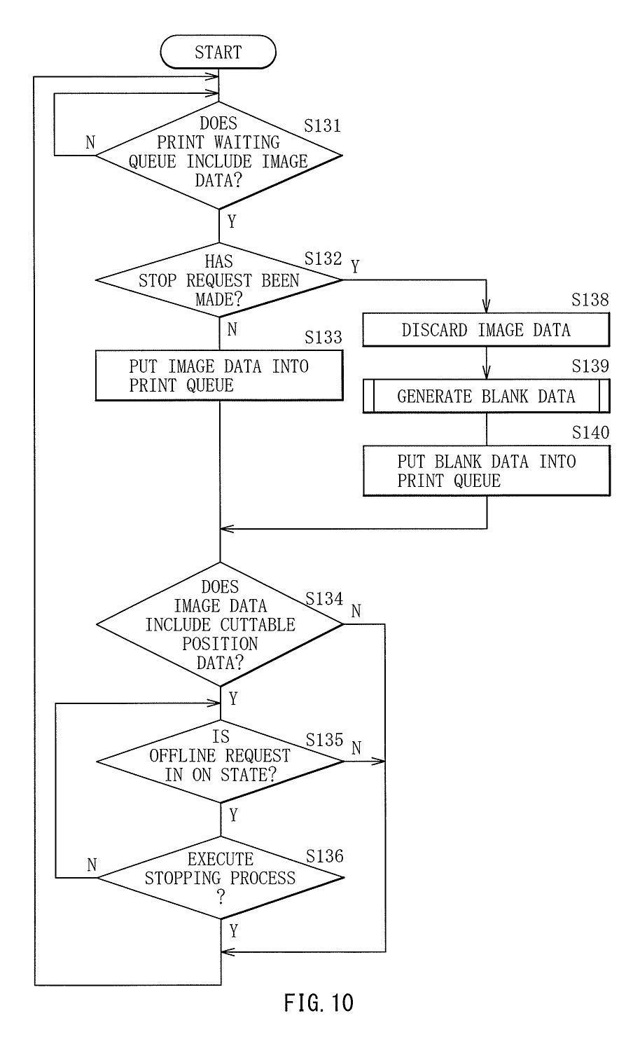

A description will be given of a process flow of the print processor 45 according to the present modification example with reference to FIG. 10. FIG. 10 is a flowchart illustrating an example a process flow of the print processor 45 according to the present modification example.

Referring to FIG. 10, the print processor 45 according to the present modification example may first confirm whether the print waiting queue includes the image data that has been subjected to the editing and expanding process by the editing and expanding processor 42 (step S131). The print processor 45 may repeat the process in step S131 until the print processor 45 confirms that the print waiting queue includes the image data that has been subjected to the editing and expanding process by the editing and expanding processor 42 (N in step S131).

When the print processor 45 confirms in step S131 that the print waiting queue includes the image data (Y in step S131), the print processor 45 may confirm whether a stop request is in the ON state or the OFF state (step S132). When the stop request is in the OFF state (N in step S132), the print processor 45 may take the image data out of the print waiting queue and put the taken-out image data into the print queue (step S133).

Thereafter, the print processor 45 may confirm whether the image data put into the print queue in step S133 includes the cuttable position data related to the continuous print medium 9 (step S134). The cuttable position data related to the continuous print medium 9 may indicate the cuttable position on the continuous print medium 9 at which the continuous print medium 9 is to be cut by the cutter 14. When the print processor 45 determines in step S134 that the image data put into the print queue does not include the cuttable position data related to the continuous print medium 9 (N in step S134), the print processor 45 may return to the process in step S131.

When the print processor 45 determines in step S134 that the image data put into the print queue includes the cuttable position data related to the continuous print medium 9 (Y in step S134), the print processor 45 may confirm whether an offline request is in the ON state or the OFF state (step S135). When the print processor 45 confirms in step S135 that the offline request is in the OFF state (N in step S135), the print processor 45 may return to the process in step S131.

When the print processor 45 confirms in step S135 that the offline request is in the ON state (Y in step S135), the print processor 45 may confirm whether the main controller 48 has so controlled the operations of the respective units in the image forming apparatus 10 as to execute the process of stopping the printing operation (step S136). When the print processor 45 cannot confirm that the main controller 48 has so controlled the operations of the respective units in the image forming apparatus 10 as to execute the process of stopping the printing operation (N in step S136), the print processor 45 may return to the process in step S135. In contrast, when the print processor 45 confirms that the main controller 48 has so controlled the operations of the respective units in the image forming apparatus 10 as to execute the process of stopping the printing operation (Y in step S136), the print processor 45 may return to the process in step S131.

In contrast, when the stop request is in the ON state in step S132 (Y in step S132), the print processor 45 may discard the image data taken out of the print waiting queue (step S138). Thereafter, the print processor 45 may generate blank data (step S139), and put the blank data into the print queue (step S140). Thereafter, the print processor 45 may perform the processes in steps S134 to S136 described above.

As described above, according to the present modification example, when the stop request is caused to be in the ON state, i.e., when the main controller 48 receives the stop signal from the operation section 43, the image data taken out of the print waiting queue may be discarded and replaced with the blank data, and the blank data may be put into the print queue, at the timing when the stop request is caused to be in the ON state, i.e., at the timing when the main controller 48 receives the stop signal from the operation section 43. Therefore, compared with the case of the example embodiment described above, it is possible to reduce consumption of a consumable such as a toner also during the printing operation continued from the time when the main controller 48 receives the stop signal to the time when the printing operation is performed to the printing end position EP.

### 3. Other Modification Examples

The technology has been described above referring to the example embodiments and the modification examples thereof. However, the technology is not limited to the example embodiments and the modification examples described above, and is modifiable in various ways. For example, the example embodiments and the modification examples thereof have been described referring to an image forming apparatus using the secondary transfer method; however, this is non-limiting. The technology is also applicable to an image forming apparatus using the primary transfer method, i.e., the direct transfer method.

Moreover, the example embodiments and the modification examples thereof have been described above referring to an example including five image forming units 30 that form a color image; however, this is non-limiting. Alternatively, four or less image forming units 30 may be provided. Alternatively, six or more image forming units 30 may be provided. Moreover, an image forming apparatus according to an example embodiment of the technology may include an image forming unit that forms a monochrome image.

Moreover, the example embodiments and the modification examples thereof have been described referring to an example case where the hardware key and the graphic panel are provided as the operation section; however, the technology is not limited thereto. For example, a touch panel may be used as the operation section.

Furthermore, the technology encompasses any possible combination of some or all of the various embodiments and the modifications described herein and incorporated herein. It is possible to achieve at least the following configurations from the above-described example embodiments of the technology.

(1)

An image forming apparatus including:

an image forming section;

a print medium conveying section that conveys a continuous print medium to the image forming section; and

a controller that receives job data and causes the image forming section to perform, on the continuous print medium, an image forming operation based on the job data, the job data including cuttable position data related to a cuttable position on the continuous print medium,

when a pause signal is received, the controller causing, on the basis of the cuttable position data, the image forming operation to be continued up to an image forming end position on the continuous print medium, and thereafter pausing the image forming operation, the pause signal giving an instruction to pause the image forming operation, the image forming end position corresponding to the cuttable position.

(2)

An image forming apparatus including:

an image forming section;

a print medium conveying section that conveys a continuous print medium to the image forming section; and

a controller that receives job data and causes the image forming section to perform, on the continuous print medium, an image forming operation based on the job data, the job data including cuttable position data related to a cuttable position on the continuous print medium,

when a pause signal is received, the controller discarding remaining part of the job data, generating blank data, causing, on the basis of the cuttable position data, the image forming operation based on the blank data to be continued up to an image forming end position on the continuous print medium, and thereafter pausing the image forming operation, the pause signal giving an instruction to pause the image forming operation, the image forming end position corresponding to the cuttable position.

(3)

The image forming apparatus according to (1) or (2), further including:

a print medium feeding section that feeds the continuous print medium to the print medium conveying section; and

a cutter that is provided between the print medium feeding section and the image forming section (3), and cuts the continuous print medium.

(4)

The image forming apparatus according to any one of (1) to (3), further including an operation section that supplies the controller with an execution signal, the pause signal, a cancel signal, and a stop signal, the execution signal giving an instruction to execute the image forming operation, the pause signal giving the instruction to pause the image forming operation, the cancel signal giving an instruction to cancel the pausing of the image forming operation, the stop signal giving an instruction to stop the image forming operation.

(5)

The image forming apparatus according to (4), in which the controller discards the job data and stops the image forming operation, when the controller receives the stop signal and the instruction to stop the image forming operation is finalized.

(6)

The image forming apparatus according to any one of (1) to (5), further including a sensor that supplies an error signal,

in which, when the error signal is received, the controller causes the image forming operation to be continued up to the image forming end position on the basis of the cuttable position data, and thereafter pauses the image forming operation, the error signal requiring pausing of the image forming operation.

(7)

An image forming method including:

conveying a continuous print medium to an image forming section;

receiving job data, the job data including cuttable position data related to a cuttable position on the continuous print medium;

causing the image forming section to perform, on the continuous print medium, an image forming operation based on the received job data;

causing the image forming operation to be continued up to an image forming end position on the continuous print medium on the basis of the cuttable position data, when a pause signal is received, the pause signal giving an instruction to pause the image forming operation, the image forming end position corresponding to the cuttable position; and

pausing the image forming operation after the causing the image forming operation to be continued up to the image forming end position on the continuous print medium, on the basis of the cuttable position data, when the pause signal is received.

(8)

An image forming method including:

conveying a continuous print medium to an image forming section;

receiving job data, the job data including cuttable position data related to a cuttable position on the continuous print medium;

causing the image forming section to perform, on the continuous print medium, an image forming operation based on the received job data;

discarding remaining part of the job data;

generating blank data;

causing the image forming operation based on the blank data to be continued up to an image forming end position on the continuous print medium, on the basis of the cuttable position data, when a pause signal is received, the pause signal giving an instruction to pause the image forming operation, the image forming end position corresponding to the cuttable position; and

pausing the image forming operation after the causing the image forming operation based on the blank data to be continued up to the image forming end position on the continuous print medium, on the basis of the cuttable position data, when a pause signal is received.

According to any of the image forming apparatus and the image forming method of one embodiment of the technology, the image forming operation is allowed to be promptly paused, which avoids useless continuation of the image forming operation. Hence, it is possible to achieve improved operability.

It is to be noted that the above example effects are mere examples of the effects of the technology. Therefore, the effects of the technology are not limited thereto. The effects of the technology may be any of the effects described herein.

Although the technology has been described in terms of exemplary embodiments, it is not limited thereto. It should be appreciated that variations may be made in the described embodiments by persons skilled in the art without departing from the scope of the invention as defined by the following claims. The limitations in the claims are to be interpreted broadly based on the language employed in the claims and not limited to examples described in this specification or during the prosecution of the application, and the examples are to be construed as non-exclusive. For example, in this disclosure, the term “preferably”, “preferred” or the like is non-exclusive and means “preferably”, but not limited to. The use of the terms first, second, etc. do not denote any order or importance, but rather the terms first, second, etc. are used to distinguish one element from another. The term “substantially” and its variations are defined as being largely but not necessarily wholly what is specified as understood by one of ordinary skill in the art. The term “about” or “approximately” as used herein can allow for a degree of variability in a value or range. Moreover, no element or component in this disclosure is intended to be dedicated to the public regardless of whether the element or component is explicitly recited in the following claims.

What is claimed is:

1. An image forming apparatus comprising:
an image forming section;
a print medium conveying section that conveys a continuous print medium to the image forming section; and
a controller that receives job data and causes the image forming section to perform, on the continuous print medium, an image forming operation based on the job data, the job data including cuttable position data related to a cuttable position on the continuous print medium,
when a pause signal is received, the controller causing, on a basis of the cuttable position data, the image forming operation to be continued up to an image forming end position on the continuous print medium, and thereafter pausing the image forming operation, the pause signal giving an instruction to pause the image forming operation, the image forming end position corresponding to the cuttable position.

2. An image forming apparatus comprising:
an image forming section;
a print medium conveying section that conveys a continuous print medium to the image forming section; and
a controller that receives job data and causes the image forming section to perform, on the continuous print medium, an image forming operation based on the job data, the job data including cuttable position data related to a cuttable position on the continuous print medium,
when a pause signal is received, the controller discarding remaining part of the job data, generating blank data, causing, on a basis of the cuttable position data, the image forming operation based on the blank data to be continued up to an image forming end position on the continuous print medium, and thereafter pausing the image forming operation, the pause signal giving an instruction to pause the image forming operation, the image forming end position corresponding to the cuttable position.

3. The image forming apparatus according to claim 1, further comprising:
a print medium feeding section that feeds the continuous print medium to the print medium conveying section; and
a cutter that is provided between the print medium feeding section and the image forming section, and cuts the continuous print medium.

4. The image forming apparatus according to claim 1, further comprising an operation section that supplies the controller with an execution signal, the pause signal, a cancel signal, and a stop signal, the execution signal giving an instruction to execute the image forming operation, the pause signal giving the instruction to pause the image forming operation, the cancel signal giving an instruction to cancel the pausing of the image forming operation, the stop signal giving an instruction to stop the image forming operation.

5. The image forming apparatus according to claim 4, wherein the controller discards the job data and stops the image forming operation, when the controller receives the stop signal and the instruction to stop the image forming operation is finalized.

6. The image forming apparatus according to claim 1, further comprising a sensor that supplies an error signal,
wherein, when the error signal is received, the controller causes the image forming operation to be continued up to the image forming end position on the basis of the cuttable position data, and thereafter pauses the image forming operation, the error signal requiring pausing of the image forming operation.

7. An image forming method comprising:
conveying a continuous print medium to an image forming section;
receiving job data, the job data including cuttable position data related to a cuttable position on the continuous print medium;
causing the image forming section to perform, on the continuous print medium, an image forming operation based on the received job data;
causing the image forming operation to be continued up to an image forming end position on the continuous print medium on a basis of the cuttable position data, when a pause signal is received, the pause signal giving an instruction to pause the image forming operation, the image forming end position corresponding to the cuttable position; and
pausing the image forming operation after the causing the image forming operation to be continued up to the image forming end position on the continuous print medium, on the basis of the cuttable position data, when the pause signal is received.

8. An image forming method comprising:
conveying a continuous print medium to an image forming section;
receiving job data, the job data including cuttable position data related to a cuttable position on the continuous print medium;
causing the image forming section to perform, on the continuous print medium, an image forming operation based on the received job data;
discarding remaining part of the job data;
generating blank data;
causing the image forming operation based on the blank data to be continued up to an image forming end position on the continuous print medium, on a basis of the cuttable position data, when a pause signal is received, the pause signal giving an instruction to pause the image forming operation, the image forming end position corresponding to the cuttable position; and
pausing the image forming operation after the causing the image forming operation based on the blank data to be continued up to the image forming end position on the continuous print medium, on the basis of the cuttable position data, when a pause signal is received.
